(19) United States
(12) Patent Application Publication
(10) Pub. No.: US 2004/0129360 A1
(43) Pub. Date: Jul. 8, 2004

(54) Tire belt based on an inorganic filler and a silane polysulfide

(76) Inventor: Pierre-Louis Vidal, Clermont-Ferrand (FR)

Correspondence Address: Alan A. Csontos, Michelin North America, Inc., Intellectual Property Department, P.O. Box 2026, Greenville, SC, 29602, US

(21) Appl. No.: 10/681,802

(22) Filed: Oct. 8, 2003

(30) Foreign Application Priority Data
Oct. 11, 2002 (FR) FR 02/12818

(51) Int. Cl. B60C 1/00; B60C 9/18; C08K 3/34

(52) U.S. Cl. 152/537; 156/123; 156/110.1; 524/493

(57) ABSTRACT

A tire belt comprising at least one elastomeric composition based on at least one isoprene elastomer, a reinforcing inorganic filler and a silane polysulfide, characterized in that said silane polysulfide satisfies the formula (I):

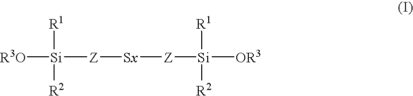

in which:

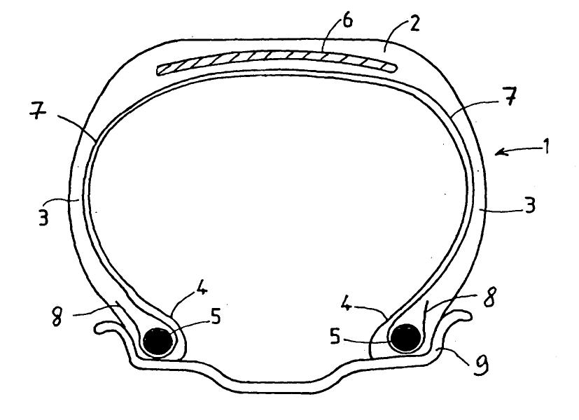

the symbols R¹ and R², which may be identical or different, each represent a monovalent hydrocarbon group selected from among alkyls, whether straight-chain or branched, having from 1 to 6 carbon atoms, and the phenyl radical;

the symbols R³, which may be identical or different, each represent hydrogen or a monovalent hydrocarbon group selected from among alkyls, whether straight-chain or branched, having from 1 to 4 carbon atoms, and alkoxyalkyls, whether straight-chain or branched, having from 2 to 8 carbon atoms;

the symbols Z, which may be identical or different, are divalent bond groups comprising from 1 to 18 carbon atoms; and

x is equal to or greater than about 2.

This application claims right of priority to French application number 02/12818, filed on 11 Oct. 2002, whose status is pending.

### BACKGROUND OF THE INVENTION

The present invention relates to tires and to the reinforcement armatures for the crown of these tires, also referred to as “belts”.

It relates more particularly to the diene elastomer compositions reinforced with an inorganic filler such as silica which are used to constitute all or part of the rubber matrix of such armatures, and also to the bonding agents used for coupling these reinforcing inorganic fillers and the diene elastomers.

A tire having a radial carcass reinforcement in known manner comprises a tread, two inextensible beads, two sidewalls joining the beads to the tread and a belt arranged circumferentially between the carcass reinforcement and the tread, this belt being formed of various plies (or “layers”) of rubber which may or may not be reinforced by reinforcement elements (“reinforcing threads”) such as cables or monofilaments, of the metallic or textile type.

A belt is generally formed of at least two superposed belt plies, sometimes referred to as “working” or “crossed” plies, the reinforcing threads of which are arranged practically parallel to one another within a ply, but crossed from one ply to the other, that is to say inclined, whether symmetrically or not, relative to the median circumferential plane, by an angle which is generally of between 10° and 45° according to the type of tire in question. Each of these two crossed plies is formed of a rubber matrix, sometimes referred to as “calendering rubber”, embedding the reinforcing threads. The crossed plies may be finished off by various other plies or auxiliary layers of rubber, of widths which are variable depending on the case, which may or may not comprise reinforcing threads; mention will be made by way of example of simple cushions of rubber, what are called “protective” plies the role of which is to protect the rest of the belt from external attack and perforations, or alternatively what are called “wrapping” plies comprising reinforcing threads oriented substantially in the circumferential direction (what are called “zero-degree” plies), be they radially external or internal relative to the crossed plies.

The belt of a tire must in known manner fulfill various demands, which are frequently contradictory, in the first place:

(i) be as rigid as possible at low deformation, because it contributes substantially to stiffening the crown of the tire;

(ii) have a hysteresis which is as low as possible, in order on one hand to minimise the heating during travel of the inner zone of the crown and on the other hand to reduce the rolling resistance of the tire, which is synonymous with saving fuel;

(iii) finally have high endurance, with respect in particular to the phenomenon of separation, cracking of the ends of the crossed plies in the “shoulder” zone of the tire, known by the name of “cleavage”, which requires in particular the compositions forming the belt plies to have high resistance to the propagation of cracks.

The third demand is particularly high for heavy-vehicle tires, designed to be able to be retreaded one or more times when the treads which they comprise reach a critical degree of wear after prolonged travel.

The elastomeric compositions of the belts of the tires are generally based on isoprene elastomer, most frequently natural rubber, and carbon black as majority reinforcing filler. They may contain, in a small proportion, a reinforcing inorganic filler such as silica, intended to improve the adhesive properties of the rubber with respect to the metallic or textile reinforcing threads.

Application EP-A-0 722 977 (or. U.S. Pat. No. 5,871,957) proposed replacing all the carbon black with silica, associated with a coupling agent of the silane polysulfide type, in order to lower the hysteresis of the rubbers and thus to reduce the rolling resistance of the tires.

However, the use of a reinforcing inorganic filler such as silica causes the well-known problem of the ability of the compositions to be worked in the uncured state (“processability”).

In known manner, for reasons of mutual attraction, the inorganic filler particles do in fact have an irritating tendency, in an elastomeric matrix in the uncured state, to agglomerate together. Apart from the fact that they may restrict the dispersion of the filler and hence the reinforcement properties, these interactions tend to increase the consistency and the viscosity of the compositions during the thermomechanical kneading operations, and therefore to make them more difficult to process, than in the presence of carbon black, once the amount of inorganic filler is relatively large. This increase in hardness is furthermore detrimental to the industrial calendering operations in the uncured state of the compositions for preparing the metallic or textile fabrics desired, or even incompatible with such operations in some cases.

The major drawback above has hitherto constituted a significant curb on the industrial development of compositions based on reinforcing inorganic filler, in the belts of tires.

### BRIEF SUMMARY OF THE INVENTION

Now, the Applicant has discovered during his research that using a specific coupling agent in the rubber compositions of the belts of tires, reinforced with an inorganic filler, makes it possible to overcome the aforementioned drawback, at least to a great extent.

What is more, this significant result is obtained without adversely affecting the other properties, quite to the contrary with an improvement in one other essential characteristic, namely the resistance to fatigue and to the propagation of cracks.

The invention thus offers the crown reinforcement armatures of tires, and also these tires themselves, an overall compromise of properties which is novel and particularly advantageous.

Consequently, a first subject of the invention relates to a tire belt comprising at least an elastomeric composition based on at least an isoprene elastomer, a reinforcing inorganic filler and a silane polysulfide, characterized in that said silane polysulfide satisfies the formula (I):

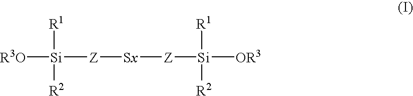

in which:

the symbols R¹ and R², which may be identical or different, each represent a monovalent hydrocarbon group selected from among alkyls, whether straight-chain or branched, having from 1 to 6 carbon atoms, and the phenyl radical;

the symbols R³, which may be identical or different, each represent hydrogen or a monovalent hydrocarbon group selected from among alkyls, whether straight-chain or branched, having from 1 to 4 carbon atoms, and alkoxyalkyls, whether straight-chain or branched, having from 2 to 8 carbon atoms;

the symbols Z, which may be identical or different, are divalent bond groups comprising from 1 to 18 carbon atoms; and

x is an integer or fractional number equal to or greater than 2.

The invention also relates to any tire comprising such a belt.

The tires of the invention are particularly intended to be fitted on motor vehicles of passenger-vehicle type, SUVs (“Sport Utility Vehicles”), two-wheeled vehicles (in particular motorcycles), aircraft, and also industrial vehicles selected from among vans, “heavy vehicles”—that is to say subway trains, buses, road transport machinery (lorries, tractors, trailers), off-road vehicles such as agricultural machinery or construction machinery—, and other transport or handling vehicles.

The subject of the invention is also the use of a belt according to the invention for the manufacture of new tires or the retreading of worn tires, very particularly in the case of heavy-vehicle tires.

The belts according to the invention are prepared by a process which constitutes another subject of the present invention; said process comprises the following steps:

incorporating in an isoprene elastomer, in a mixer:

a reinforcing inorganic filler;

a silane polysulfide as coupling agent, thermomechanically kneading the entire mixture, in one or more stages, until a maximum temperature of between 110° C. and 190° C. is reached;

cooling the entire mixture to a temperature of less than 100° C.;

then incorporating a vulcanization system;

kneading the entire mixture until a maximum temperature less than 110° C. is reached,

calendering or extruding the composition thus obtained in the form of a layer of rubber, and

incorporating this layer, after the optional addition of textile or metallic reinforcing threads, in the tire belt,

wherein said silane polysulfide satisfies the above formula (I).

### BRIEF DESCRIPTION OF THE DRAWING

The invention and its advantages will be readily understood in the light of the description and examples of embodiment which follow, and of the diagrammatic FIGURE relating to these examples, which shows a radial section through a heavy-vehicle tire having a radial carcass reinforcement.

### DETAILED DESCRIPTION OF THE INVENTION

I. Measurements and Tests Used

The rubber compositions are characterized before and after curing, as indicated below.

A) Mooney Plasticity:

An oscillating consistometer such as described in French Standard NF T 43-005 (1991) is used. The Mooney plasticity is measured in accordance with the following principle: the raw composition (i.e. before curing) is moulded in a cylindrical enclosure heated to 100° C. After one minute's preheating, the rotor turns within the test piece at 2 rpm, and the torque used for maintaining this movement is measured after four minutes' rotation. The Mooney plasticity (MS 1+4) is expressed in “Mooney units” (MU, with 1 MU=0.83 Newton.meter).

B) Rheometry:

The measurements are effected at 150° C. with an oscillating-chamber rheometer, in accordance with DIN Standard 53529—part 3 (June 1983). The evolution of the rheometric torque as a function of time describes the evolution of the stiffening of the composition following the vulcanization reaction. The measurements are processed in accordance with DIN Standard 53529—part 2 (March 1983): tᵢ is the induction delay, that is to say, the time necessary for the start of the vulcanization reaction; t_{α} (for example t₉₅) is the time necessary to achieve a conversion of α%, that is to say α% (for example 95%) of the deviation between the minimum and maximum torques. The conversion rate constant K (expressed in min⁻¹) of order 1, calculated between 30% and 80% conversion, is also measured, which makes it possible to assess the vulcanization kinetics.

C) Tensile Tests:

These tests make it possible to determine the elasticity stresses and the properties at break. Unless indicated otherwise, they are effected in accordance with French Standard NF T 46-002 of September 1988. The “nominal” secant moduli (or apparent stresses, in MPa) or “true” secant moduli (reduced in this case to the real section of the test piece) at 10% elongation (“ME10” and “E10”, respectively) and 100% elongation (“ME100” and “E100”) are measured in a second elongation (i.e. after an accommodation cycle). All these tensile measurements are effected under normal conditions of temperature (23±2° C.) and humidity (50±5% relative humidity), in accordance with French standard,NFT 40-101 (December 1979). The breaking-stresses (in MPa) and the elongations at break (in %) are also measured at a temperature of 100° C.

D) Dynamic Properties:

The dynamic properties are measured on a viscoanalyzer (Metravib VA4000), in accordance with ASTM Standard D5992-96. The response of a sample of vulcanized composition (cylindrical test piece of a thickness of 4 mm and a section of 400 mm²), subjected to an alternating single sinusoidal shearing stress, at a frequency of 10 Hz, at a temperature of 100° C., is recorded. Scanning is effected at an amplitude of deformation of 0.1 to 50% (outward cycle), then of 50% to 1% (return cycle); for the return cycle, the maximum value of the loss factor, tan(δ)ₘₐₓ, is recorded.

E) “MFTRA” Test:

The resistance to fatigue and to propagation of notches (with starting tear), expressed in number of cycles or in relative units (r.u.), is measured in known manner on a test piece comprising a 1 mm notch and subjected to repeated low-frequency traction until an elongation of 20% is achieved, using a Monsanto apparatus (type “MFTR”), until the test piece breaks, in accordance with French Standard NF T46-021.

II. Conditions of Implementation of the Invention

The belts of tires of the invention have the essential characteristic of incorporating, in all or part of their rubber matrix, at least one elastomeric composition based on at least each of the following constituents: (i) a (at least one) isoprene elastomer; (ii) a (at least one) inorganic filler as reinforcing filler, (iii) a (at least one) specific silane polysulfide of formula (I) as (inorganic filler/isoprene elastomer) coupling agent. Of course, the expression composition “based on” is to be understood to mean a composition comprising the mix and/or the product of reaction in situ of the various constituents used, some of these base constituents being liable to, or intended to, react together, at least in part, during the different phases of manufacture of the rubber compositions, belts and tires, in particular during the vulcanization thereof. In the present description, unless expressly indicated otherwise, all the percentages (%) indicated are mass %. 11-1. Diene elastomer “Diene” elastomer (or rubber) is understood to mean, generally, an elastomer resulting at least in part (i.e. a homopolymer or a copolymer) from diene monomers, that is to say from monomers bearing two double carbon-carbon bonds, whether conjugated or not. “Essentially unsaturated” diene elastomer is understood here to mean a diene elastomer resulting at least in part from conjugated diene monomers, having a content of members or units of diene origin (conjugated dienes) which is greater than 15% (mol %); within the category of “essentially unsaturated” diene elastomers, “highly unsaturated” diene elastomer is understood to mean in particular a diene elastomer having a content of units of diene origin (conjugated dienes) which is greater than 50%. These general definitions being given, in the present application “isoprene elastomer” is understood to mean, in known manner, an isoprene homopolymer or copolymer, in other words a diene elastomer selected from the group consisting of natural rubber (NR), synthetic polyisoprenes (1R), the various isoprene copolymers and mixtures of these elastomers. Of the isoprene copolymers, mention will be made in particular of isobutene/isoprene copolymers (butyl rubber —IIR), isoprene/styrene copolymers (SIR), isoprene/butadiene copolymers (BIR) or isoprene/butadiene/styrene copolymers (SBIR). This isoprene elastomer is preferably natural rubber or a synthetic polyisoprene of the cis-1,4 type. Of these synthetic polyisoprenes, preferably polyisoprenes having a content (mole %) of cis-1,4 bonds greater than 90%, more preferably still greater than 98%, are used. In a blend (i.e. mixture) with the isoprene elastomer above, the compositions of the invention may contain diene elastomers other than isoprene elastomers, preferably in aminority proportion (i.e., less than 50% by weight, or less than 50 phr); in such a case, the isoprene elastomer more preferably represents 75 to 100% by weight of the total of diene elastomer, or 75 to 100 phr (parts by weight per hundred parts of elastomer). As for such diene elastomers other than isoprene elastomers, mention will be made in particular of any highly unsaturated diene elastomer selected in particular from the group consisting of polybutadienes (BR), in particular cis-1,4 or syndiotactic 1,2-polybutadienes and those having a content of 1,2 units of between 4% and 80%, and butadiene copolymers, in particular styrene-butadiene copolymers (SBR), and in particular those having a styrene content of between 5 and 50% by weight and more particularly between 20% and 40% by weight, a content of 1,2-bonds of the butadiene fraction of between 4% and 65%, a content of trans-1,4 bonds of between 30% and 80%, styrene/butadiene/isoprene copolymers (SBIR), and mixtures of these different elastomers (BR, SBR and SBIR). By way of example, when the belt of the invention is intended for a tire of passenger-car type, if such a blend is used, it is preferably a mixture of SBR and BR which is used in a blend with natural rubber up to 25% by weight (or a maximum of 25 phr). The belt of the invention is particularly intended for a heavy-vehicle tire, be it a new or a used tire (case of retreading). In such a case, the isoprene elastomer is preferably used on its own, that is to say without being blended with another diene elastomer or polymer; more preferably still, this isoprene elastomer is exclusively natural rubber.

II-2. Reinforcing Inorganic Filler

In the present application, “reinforcing inorganic filler”, in known manner, is understood to mean an inorganic or mineral filler, whatever its colour and its origin (natural or synthetic), also referred to as “white” filler or sometimes “clear” filler in contrast to carbon black, this inorganic filler being capable, on its own, without any other means than an intermediate coupling agent, of reinforcing a rubber composition intended for the manufacture of tires, in other words being capable of replacing a conventional tire-grade carbon black filler in its reinforcement function. The white or inorganic filler used as reinforcing filler may constitute all or only part of the total reinforcing filler, in this latter case associated, for example, with carbon black. Preferably, the reinforcing inorganic filler constitutes the majority, that is to say, more than 50%, of the total reinforcing filler, more preferably more than 80% of this total reinforcing filler. Any type of reinforcing inorganic filler known for its ability to reinforce a rubber composition usable for the manufacture of tires, in particular intended for the belt or the tread thereof, may be used. Suitable reinforcing inorganic fillers are in particular mineral fillers of siliceous type, in particular silica (SiO₂), or of aluminous type, in particular alumina (Al₂O₃) or aluminium (oxide-)hydroxides. The silica used may be any reinforcing silica known to the person skilled in the art, in particular any precipitated or ftuned silica having a BET surface area and a specific CTAB surface area both of which are less than 450 m²/g, preferably from 30 to 400 m²/g. Precipitated silicas of highly dispersible type (referred to as “HDS”) can be notably used, in particular when the invention is used for the manufacture of tires having low rolling resistance. As examples of silicas which can be used, mention may be made of the silicas Ultrasil VN2, Ultrasil VN3, Ultrasil 7000 GR, Ultrasil 7005 from Degussa, the silicas Zeosil 1165 MP, 1135 MP, 1115 MP from Rhodia, the silica Hi-Sil EZ150G from PPG, the silicas Zeopol 8715, 8745 et 8755 from Huber, and treated precipitated silicas such as, for example, the aluminium-“doped” silicas described in application EP-A-0 735 088. The reinforcing alumina preferably used is an alumina having a BET surface area from 30 to 400 m²/g, more preferably between 60 and 250 m²/g, and an average particle size at most equal to 500 nm, more preferably at most equal to 200 nm, as described in application EP-A-810258. Non-limiting examples of such reinforcing aluminas are in particular the aluminas “Baikalox”, “A125” or “CR125” (from Baikowski), “APA-100RDX” (from Condea), “Aluminoxid C” (from Degussa) or “AKP-G015” (Sumitomo Chemicals). When the belt according to the invention is intended for a tire for an industrial vehicle of the heavy-vehicle type, a preferred embodiment of the invention consists of using a reinforcing inorganic filler, in particular a silica, having a high BET specific surface area, greater than 130 m²/g, more preferably within a range from 150 to 250 m²/g, owing to the recognized high reinforcing ability of such fillers. According to a preferred embodiment of the invention, the reinforcing inorganic filler comprises more than about 50% and up to 100% of silica. The physical state in which the reinforcing inorganic filler is present is immaterial, whether it be in the form of a powder, microbeads, granules or alternatively balls. Of course, “reinforcing inorganic filler” is also understood to mean mixtures of different reinforcing inorganic fillers, in particular of highly dispersible silicas and/or aluminas such as described above. The reinforcing inorganic filler may also be used in a blend with carbon black, preferably in a minority proportion (i.e. less than 50%). Suitable blacks are all the carbon blacks, in particular those of the type HAF, ISAF, SAF, conventionally used in tires (blacks referred to as “tire-grade”), and in particular in belts for these tires, such as, for example, the carbon blacks of series 300 (N326, N330, N339, N347, N375, etc.). In the belts of the invention, it is preferred to use, in association with the reinforcing inorganic filler, a carbon black in an amount of between 2 and 20 phr, more preferably within a range from 5 to 15 phr. Within the ranges indicated, it was noted that there was a benefit to be had from the colouring properties (black pigmentation agent) and anti-UV properties of the carbon blacks, without furthermore adversely affecting the typical performance provided by the reinforcing inorganic filler, notably the low hysteresis. Preferably, the amount of reinforcing inorganic filler is between 30 and 150 phr, more preferably between 40 and 120 phr, the optimum differing according to the intended applications, because the level of reinforcement expected of a passenger-car tire is known to be lower than that required for a heavy-vehicle tire capable of withstanding heavy loads while travelling at a sustained high speed. In this latter case, the amount of reinforcing inorganic filler is preferably greater than 50 phr, more preferably greater than 55 phr, for example, advantageously, between 60 and 100 phr. In the present specification, the BET specific surface area is determined by adsorption of gas using the method of Brunauer-Emmett-Teller described in “The Journal of the American Chemical Society” Vol. 60, page 309, February 1938, more precisely in accordance with French Standard NF ISO 9277 of December 1996 [multipoint volumetric method (5 points)—gas: nitrogen—degassing: 1 hour at 160° C.—range of relative pressure p/po: 0.05 to 0.17]. The CTAB specific surface area is the external surface area determined in accordance with French Standard NF T 45-007 of November 1987 (method B). Finally, the person skilled in the art will understand that, as filler equivalent to the reinforcing inorganic filler described in the present section, there could be used a reinforcing organic filler, in particular a carbon black, covered at least in part with an inorganic layer, for example silica, which for its part requires the use of a coupling agent to provide the bond to the diene elastomer.

II-3. Coupling Agent

It will be recalled here that “coupling agent” is understood to mean, in known manner, an agent capable of establishing a sufficient chemical and/or physical bond between the inorganic filler and the diene elastomer; such a coupling agent, which is at least bifunctional, has, for example, the simplified general formula “Y-A-X”, in which:

Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica);

X represents a functional group (“X” function) which is capable of bonding physically and/or chemically with the diene elastomer, for example by means of a sulfur atom;

A represents a divalent group making it possible to link Y and X. The coupling agents must in particular not be confused with simple agents for covering the inorganic filler which, in known manner, may comprise the “Y” function which is active with respect to the inorganic filler but are devoid of the “X” function which is active with respect to the diene elastomer. Coupling agents, in particular (silica/diene elastomer) coupling agents, have been described in a very large number of documents, the best known being bifunctional organosilanes bearing alkoxyl functions (that is to say, by definition, “alkoxysilanes”) as “Y” functions and, as “X” functions, functions capable of reacting with the diene elastomer, such as, for example, polysulfide functions (see for example U.S. Pat. No. 3,842,111, U.S. Pat. No. 3,873,489, U.S. Pat. No. 3,997,581; applications EP-A-722 977, EP-A-735 088, EP-A-810 258, WO 96/37547, WO 97/42256, WO 98/42778, WO 99/28391, WO 00/05300, WO 00/05301, WO 01/55252, WO 01/55253, WO O₂/10269). Among all the known alkoxysilane polysulfide compounds, mention should be made in particular of bis-(trialkoxysilylpropyl) polysulfides, very particularly bis-3-triethoxysilylpropyl disulfide (abbreviated to “TESPD”) and bis-3-triethoxysilylpropyl tetrasulfide (abbreviated to “TESPT”). It will be recalled that TESPD, of formula [(C₂HsO)₃Si(CH₂)₃S]₂, is in particular sold by Degussa under the names Si266 or Si75 (in the latter case, in the form of a mixture of disulfide (75% by weight) and of polysulfides). TESPT, of formula [(C₂H₅O)₃Si(CH₂)₃S₂]₂, is sold in particular by Degussa under the name Si69 (or X50S when it is supported to 50% by weight on carbon black), in the form of a commercial mixture of polysulfides SX having an average value of x which is close to 4. TESPT, in particular, is nowadays considered as the product providing the best compromise in terms of resistance to scorching, hysteresis and reinforcing ability, for rubber compositions reinforced with a reinforcing inorganic filler such as silica. It is therefore the coupling agent of reference for the person skilled in the art for tires filled with silica of low rolling resistance, sometimes referred to as “Green Tires” because of the energy saving offered (or “energy-saving Green Tires”), including for the belts of these tires (see the aforementioned EP-A-722 977). The specific silane polysulfide used in the belts of the tires according to the invention corresponds to the general formula:

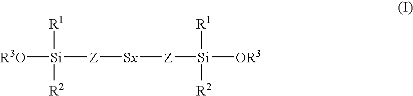

in which:

the symbols R¹ and R², which may be identical or different, each represent a monovalent hydrocarbon group selected from among alkyls, whether straight-chain or branched, having from 1 to 6 carbon atoms, and the phenyl radical;

the symbols R³, which may be identical or different, each represent hydrogen or a monovalent hydrocarbon group selected from among alkyls, whether straight-chain or branched, having from 1 to 4 carbon atoms, and alkoxyalkyls, whether straight-chain or branched, having from 2 to 8 carbon atoms;

the symbols Z, which may be identical or different, are divalent bond groups comprising from 1 to 18 carbon atoms; and

x is an integer or fractional number equal to or greater than 2. It can clearly be seen that to provide the bond between the diene elastomer and the reinforcing inorganic filler, it comprises per molecule:

firstly, as “X” function, a polysulfide functional group (Sₓ) capable of forming a stable bond with the diene elastomer;

secondly, as “Y” function, one and only one group (—OR³) per silicon atom—(≡Si—OR³ function)—enabling it to be grafted on to the reinforcing inorganic filler by means of its surface hydroxyl groups; and

the two linkages Z providing the bond between the polysulfurized group at the center of the molecule and the two (≡Si—OR³) functions fixed to each end of the molecule.

The groups Z comprising from 1 to 18 carbon atoms represent in particular an alkylene chain, a saturated cycloalkylene group, an arylene group, or a divalent group formed of a combination of at least two of these groups. They are preferably selected from among C₁-C₁₈ alkylenes and C₆-C₁₂ arylenes; they may be substituted or interrupted by one or more heteroatoms, selected in particular from among S, O, and N.

In formula (I) above, preferably the following characteristics are satisfied:

the symbols R¹ and R² are selected from among methyl, ethyl, n-propyl, and isopropyl;

the symbol R³ is selected from among hydrogen, methyl, ethyl, n-propyl, and isopropyl;

the symbols Z are selected from among C₁-C₈ alkylenes.

More preferably still,

the symbols R¹ and R² are selected from among methyl and ethyl;

the symbol R³ is selected from among hydrogen, methyl, and ethyl;

the symbols Z are selected from among C₁-C₄ alkylenes, in particular methylene, ethylene or propylene, more particularly propylene —(CH₂)₃—.

As preferred examples of polysulfides of formula (I), mention will be made in particular of bis-monoalkoxydimethylsilylpropyl polysulfides and mixtures of these polysulfides, in particular those of specific formulae (II), (III) or (IV) hereafter:

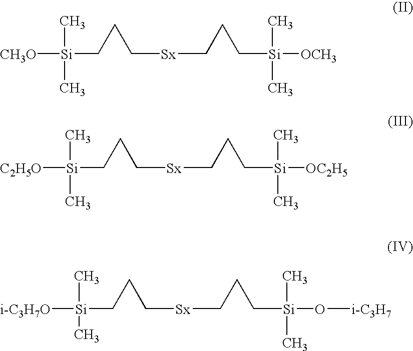

By way of a preferred example of monohydroxysilane polysulfide of formula (I), mention may also be made of the one of specific formula (V) hereafter:

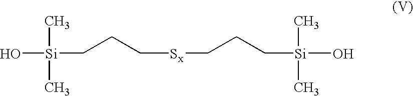

In formulae (I) to (V) above, in the case in which the synthesis method of the silane polysulfide in question can give rise to only one sort of polysulfide, the number x is then an integer, preferably within a range from 2 to 8.

The polysulfides are preferably selected from among disulfides (x=2), trisulfides (x=3), tetrasulfides (x=4), pentasulfides (x=5), hexasulfides (x=6) and mixtures of these polysulfides, more particularly from among disulfides, trisulfides and tetrasulfides.

More preferably, the disulfides, trisulfides or tetrasulfides of bis-monoethoxydimethylsilylpropyl (formula (III) above) are in particular selected. The person skilled in the art will readily understand that, when the synthesis method gives rise to a mixture of polysulfurized groups each having a different number of sulfur atoms (typically S₂ to S₈), then this number x is generally a fractional number the average value of which may vary according to the synthesis method used and the specific conditions of this synthesis. In such a case, the synthesised polysulfide is in fact formed of a distribution of polysulfides centred on an average value (in mole) of the “x”s preferably of from 2 to 8, more preferably from 2 to 6, even more preferably within a range from 2 to 4. More preferably still, a silane tetrasulfide is used. “Tetrasulfide” is understood in the present application to mean the tetrasulfide S₄ proper and also any mixture of polysulfides SX the average number of atoms of S (“x”) of which, per molecule of silane, is of between 3 and 5, in particular within a range from 3.5 to 4.5. According to a particularly preferred embodiment of the invention, there is used the monoethoxydimethylsilylpropyl (abbreviated to “MESPT”) of general formula (III) above, the monoethoxylated homologue of the aforementioned TESPT, of structural formula (VI) (Et=ethyl):

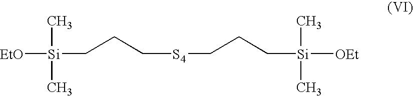

According to another specific embodiment of the invention, there can be used the monoethoxydimethylsilylpropyl disulfide (abbreviated to “MESPD”) of general formula (III), the monoethoxylated homologue of the aforementioned TESPD, having as structural formula (VII) (x close to 2):

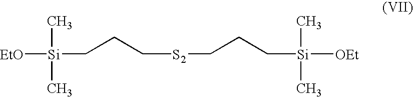

According to another specific embodiment of the invention, there can also be used the monohydroxydimethylsilylpropyl tetrasulfide of general formula (V), having the structural formula (VIII):

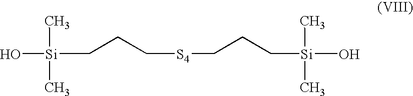

Silane polysulfide compounds corresponding to formulae (I) to (VIII) above have been described in the prior art, for example in applications EP-A-680 997 (or U.S. Pat. No. 5,650,457), WO O₂/30939, WO O₂/31041, EP-A-1 043 357 (or CA-A-2 303 559), FR-A-2 823 215 (filing no. FR01/05005) where they are used as examples in SBR-type rubber compositions usable for the manufacture of treads for passenger-car tires. The person skilled in the art will be able to adjust the content of polysulfide of formula (I) as a function of the specific embodiments of the invention, in particular of the quantity of reinforcing inorganic filler used, the preferred amount representing between 2% and 20% by weight relative to the quantity of reinforcing inorganic filler; amounts less than 15%, in particular less than 10%, are more particularly preferred. So as to make allowance for the differences in specific surface area and density of the reinforcing inorganic fillers which may be used, as well as the molar masses of the polysulfide coupling agents specifically used, it is preferable to determine the optimum amount of coupling agent in moles/m² of inorganic filler; this optimum amount is calculated from the weight ratio [coupling agent/inorganic filler], the BET surface area of the filler and the molar mass of the coupling agent (referred to as M hereafter), according to the known equation:

(moles/m² inorganic filler)=[coupling agent/inorganic filler] (1/BET) (1/M)

Thus, preferably, the quantity of polysulfide coupling agent used in the compositions lies between 10-7 and 10-5 moles per m² of reinforcing inorganic filler. More preferably still, this quantity lies between 5×10⁻⁷ and 5×10⁻⁶ moles per m² of inorganic filler. Taking into account the quantities expressed above, generally, the content of silane polysulfide is preferably between 2 and 20 phr. Below the minimum amount indicated, the effect risks being inadequate, whereas beyond the maximum amount advocated generally no further improvement is observed, while the costs of the composition increase; for these various reasons, this content is more preferably still between 2 and 10 phr. The person skilled in the art will understand on the other hand that the silane polysulfide of formula (I) could be grafted on to the inorganic filler beforehand (for example via its alkoxysilyl, in particular ethoxysilyl, function), the filler thus “precoupled” then being able to be bonded to the diene elastomer by means of the free polysulfide function.

II-4. Various Additives

The rubber matrices of the belts according to the invention also comprise all or some of the usual additives used in rubber compositions intended for the manufacture of tire belts, such as for example extender oils, plasticizers, protection agents such as antiozone waxes, chemical antiozonants, antioxidants, anti-fatigue agents, coupling activators such as described for example in applications WO00/05300, WO00/05301, WO01/55252, WO01/55253, methylene acceptors and donors, bismaleimides or other reinforcing resins such as described for example in WO02/10269, a cross-linking system based on either sulfur or on sulfur and/or peroxide donors, vulcanization accelerators, vulcanization activators or retarders, systems promoting adhesion of the rubber to the metal such as for example metal salts or complexes (for example of cobalt, boron, or phosphorus). The isoprene matrices invention may also contain, in addition to the silane polysulfides previously described, agents for covering the reinforcing inorganic filler, comprising for example the single function Y, or more generally processing aids liable, in known manner, owing to an improvement in the dispersion of the inorganic filler in the rubber matrix and to a reduction in the viscosity of the compositions, to improve their processability, these agents being, for example, alkylalkoxysilanes, in particular alkyltriethoxysilanes, such as, for example, 1-octyl-triethoxysilane sold by Degussa-Hüls under the name Dynasylan Octeo or 1 -hexa-decyl-triethoxysilane sold by Degussa-Hüls under the name Si216, polyols, polyethers, (for example polyethylene glycols), primary, secondary or tertiary amines, (for example trialkanolamines), hydroxylated or hydrolysable polyorganosiloxanes, for example α,ω-dihydroxy-polyorganosiloxanes (in particular α,ω-dihydroxy-polydimethylsiloxanes).

II-5. Belts and Tires According to the Invention

The isoprene compositions previously described are intended to form all or part of the rubber matrix of the belt of a tire, in particular of a heavy-vehicle tire. They can for example be used as calendering rubber for a belt ply of cabled fabric, be it a “crossed” ply, a protective ply or a (zero-degree) wrapping ply, or intended to form a simple cushion, band or strip of rubber, devoid of reinforcing threads, arranged radially above or below the aforementioned different belt plies, or even interposed between the latter, for example to constitute an underlayer of the tread, or alternatively placed at the lateral ends of these belt plies, in the “shoulder” zones of the tire, for example to constitute decoupling rubbers. By way of example, the appended figure shows diagrammatically a radial section through a heavy-vehicle tire 1 having a radial carcass reinforcement which may or may not be in accordance with the invention, in this general representation. This tire 1 comprises a crown 2, two sidewalls 3, two beads 4 and a radial carcass reinforcement 7 extending from one bead to the other. The crown 2, which is surmounted by a tread (not shown in this very diagrammatic figure, for purposes of simplification) is in known manner reinforced by a belt 6 formed of at least two “crossed” crown plies, covered by at least one protective crown ply, all these plies being reinforced by metal cables of carbon steel. The carcass reinforcement 7 is wound around the two bead wires 5 within each bead 4, the upturn 8 of this reinforcement 7 being for example arranged towards the outside of the tire 1, which is shown here mounted on its rim 9. The carcass reinforcement 7 is formed of at least one ply reinforced by so-called “radial” metal cables, that is to say that these cables are arranged practically parallel to each other and extend from one bead to the other so as to form an angle of between 80° and 90° with the median circumferential plane (plane perpendicular to the axis of rotation of the tire which is located halfway between the two beads 4 and passes through the centre of the belt 6). The tire according to the invention of the example above has the essential characteristic of comprising in its crown 2 a belt 6 according to the invention, the isoprene composition based on inorganic filler and the silane polysulfide of formula (I) constituting the calendering rubber of the three belt plies 6 (2 crossed plies and 1 protective ply in this example). In the case of a tire comprising for example one or more “zero-degree” plies, it is preferable for the calendering rubber of the cabled fabric, be it in the form of a ply of a certain width, close to the width of the crossed plies, of narrower strips or even of a unit thread sheathed with rubber, to be also based on a reinforcing inorganic filler and the silane polysulfide of formula (I). According to a preferred embodiment of the invention, the rubber composition based on the isoprene elastomer, the reinforcing inorganic filler and the silane polysulfide of formula (I) has, in the vulcanized state (i.e., after curing), a secant tensile modulus (E1 0) which is greater than 5 MPa, more preferably of between 9 and 20 MPa. It is in the field of moduli indicated above that the best compromise in terms of endurance was recorded.

II-6. Preparation of the Rubber Compositions

The rubber compositions are manufactured in suitable mixers, using two successive preparation phases well-known to the person skilled in the art: a first phase of thermomechanical working or kneading (sometimes referred to as “non-productive” phase) at high temperature, up to a maximum temperature (Tₘₐₓ) of between 110° C. and 190° C., preferably between 130° C. and 180° C., followed by a second phase of mechanical working (sometimes referred to as “productive” phase) at lower temperature, typically less than 110° C., for example between 40° C. and 100° C., during which finishing phase the cross-linking or vulcanization system is incorporated. The process for manufacturing the compositions according to the invention is characterized in that at least the reinforcing inorganic filler and the silane polysulfide of formula (I) are incorporated by kneading in the isoprene elastomer during the first, so-called non-productive, phase, that is to say that there are introduced into the mixer and kneaded thermomechanically, in one or more stages, at least these different base constituents until a maximum temperature of between 110° C. and 190° C., preferably of between 130° C. and 180° C., is achieved. By way of example, the first (non-productive) phase is effected in a single thermomechanical step during which in a first phase all the base constituents necessary (isoprene elastomer, reinforcing inorganic filler and silane polysulfide), then in a second phase, for example after one to two minutes' kneading, any complementary covering agents or processing agents and various other additives, with the exception of the vulcanization system, are introduced into a suitable mixer, such as a conventional internal mixer; when the apparent density of the reinforcing inorganic filler is low (generally the case of silicas), it may be advantageous to divide the introduction thereof into two or more parts. A second step of thermomechanical working may be added in this internal mixer, after the mixture has dropped and after intermediate cooling (cooling temperature preferably less than 100° C.), with the aim of making the compositions undergo complementary thermomechanical treatment, in particular in order to improve further the dispersion, in the elastomeric matrix, of the reinforcing inorganic filler and its coupling agent. The total duration of the kneading, in this non-productive phase, is preferably between 2 and 10 minutes. After cooling of the mixture thus obtained, the vulcanization system is then incorporated at low temperature, generally in an external mixer such as an open mill; the entire mixture is then mixed (productive phase) for several minutes, for example between 5 and 15 minutes. The final composition thus obtained is then calendered, for example in the form of thin slabs (thickness of 2 to 3 mm) or thin sheets of rubber in order to measure its physical or mechanical properties, in particular for laboratory characterization, or alternatively extruded to form a rubber profiled element usable directly, after cutting out or assembly to the dimensions desired, and addition of the metallic or textile reinforcing threads desired, as belt ply. In summary, the process according to the invention for preparing a tire belt according to the invention, comprising an isoprene elastomer composition based on a reinforcing inorganic filler and a silane polysulfide coupling agent, comprises the following steps:

incorporating in an isoprene elastomer, in a mixer:

a reinforcing inorganic filler;

a silane polysulfide as coupling agent,

thermomechanically kneading the entire mixture, in one or more stages, until a maximum temperature of between 110° C. and 190° C. is reached;

cooling the entire mixture to a temperature of less than 100° C.;

then incorporating a vulcanization system;

kneading the entire mixture until a maximum temperature of less than 110° C. is reached;

calendering or extruding the composition thus obtained in the form of a layer of rubber; and

incorporating this layer, after the possible addition of textile or metallic reinforcing threads, in the intended tire belt, and it is characterized in that said silane polysulfide satisfies the above formula (I). The vulcanization or curing is carried out in known manner at a temperature preferably between 130° C. and 200° C., under pressure, for a sufficient time which may vary, for example, between 5 and 90 minutes, depending, in particular, on the curing temperature, the vulcanization system adopted, the vulcanization kinetics and the size of the tire in question. The cross-linking system proper is preferably based on sulfur and a primary vulcanization accelerator, in particular an accelerator of sulfenamide type. To this vulcanization system there are added, incorporated during the first non-productive phase and/or during the productive phase, various known secondary accelerators or vulcanization activators such as zinc oxide, stearic acid, guanidine derivatives (in particular diphenylguanidine), vulcanization retarders, etc. The sulfur is used in a preferred amount of between 1 and 10 phr, more preferably of between 2 and 8 phr, in particular when the invention is applied to a tire of heavy-vehicle type. The primary vulcanization accelerator is used in a preferred amount of between 0.5 and 5 phr, more preferably of between 0.5 and 2 phr. It goes without saying that the invention relates to the belts and tires previously described, both in the “uncured” state (i.e. before curing) and in the “cured” or vulcanized state (i.e. after cross-linking or vulcanization).

### III. EXAMPLES OF EMBODIMENT

III-1. Preparation of the Rubber Compositions

For the following tests, the procedure is as follows: the isoprene elastomer (or the mixture of diene elastomers, if applicable), the reinforcing filler, the coupling agent, then, after one to two minutes' kneading, the various other ingredients, with the exception of the vulcanization system, are introduced into an internal mixer filled to 70%, the initial tank temperature of which is approximately 60° C. Thermomechanical working (non-productive phase) is then performed in one or two steps (total duration of kneading equal for example to about 7 minutes), until a maximum “dropping” temperature of about 165-170° C. is reached. The mixture thus obtained is recovered, it is cooled and then the vulcanization system (sulfur and sulfenamide primary accelerator) are added on an external mixer (homo-finisher) at 30° C., by mixing everything (productive phase) for example for 3 to 10 min.

The compositions thus obtained are then either extruded in the form of thin slabs (thickness of 2 to 3 mm) in order to measure their physical or mechanical properties, or calendered in order to produce a metallic cabled fabric forming a “working” belt ply for a heavy-vehicle tire. 15. 111-2. Characterisation tests The object of this test is to demonstrate the improved performance of an isoprene composition based on a reinforcing inorganic filler (silica) and a silane polysulfide of formula (I), compared on one hand with a first control composition using carbon black (without coupling agent) as reinforcing filler, and on the other hand with a second control composition using silica as reinforcing filler and a conventional silane polysulfide as coupling agent.

For this, three compositions are prepared, based on natural rubber:

composition C-i: carbon black (control 1);

composition C-2: silica+TESPT (control 2); and

composition C-3: silica+MESPT (invention).

These 3 compositions are intended to constitute the “calendering rubber” of working plies of a belt of a heavy-vehicle tire. Composition C-1 is the control composition based on carbon black; composition C-2 is a composition based on silica according to the prior art (aforementioned EP-A-722 977); only composition C-3 is in accordance with the invention.

In compositions C-2 and C-3, the two tetrasulfurized alkoxysilanes are used in a substantially isomolar amount of silicon (base x=4), that is to say that, whatever the composition tested, the same number of moles of “Y” functions (Si≡(OEt)a; with “a” equal to 1 or 3) which are reactive with respect to the silica and its hydroxyl surface groups is used. The amount thereof represents less than 10% by weight relative to the quantity of reinforcing inorganic filler, less than 7% for the composition according to the invention.

It will be recalled that TESPT, which is the coupling agent of reference for the compositions based on silica, has the structural formula (Et=ethyl):

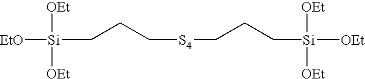

In this test the TESPT sold by Degussa under the name “Si69” (average x equal to 3.75 according to the supplier's data sheet) is used. The structure above is therefore very close to that of the MESPT of formula (VI):

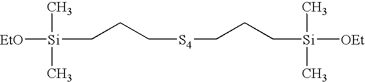

the latter differing therefrom only in the presence of a single ethoxyl group (and two methyl groups) instead of the usual three ethoxyl groups. The MESPT above was prepared as follows (see aforementioned FR-A-2 823 215). 91.9 g of sodium ethanolate (1.352 mole, or the equivalent of 2 moles per 1 mole of H₂S) in solution at 21 mass % in ethanol (438 g) and 250 ml of toluene are introduced in a current of argon into the bottom of a 3-litre double-casing glass reactor which is fitted with a condenser, a mechanical stirring means (Rushton turbine), a thermocouple, a gas feed pipe (argon or H₂S) and an intake for the peristaltic pump. The whole is stirred (200-300 rpm). A weight of 65 g of sulfur (2.031 moles, or the equivalent of 3 moles per one mole of H₂S) is then added. After purging the circuits with argon, the H₂S (23 g, or 0.676 mole) is introduced by bubbling by means of a dip tube, namely for 45 to 60 minutes. The solution changes from an orange coloration with yellow-orange particles to a dark brown coloration without particles. Under a current of argon, the mixture is heated to 60° C. for 1 hour so as to complete the conversion into anhydrous Na₂S₄. The reaction medium changes from a dark brown to a red-brown colour with brown particles: The reaction medium is then cooled using a refrigeration means (at 10-15° C.) to reach a temperature close to 20° C. A weight of 244 g γ-chloropropylethoxydimethylsilane (1.352 moles, or the equivalent of 2 moles per mole of H₂S) is added by means of a peristaltic pump (10 ml/min) over 30 minutes. The reaction medium is then heated to 75±2° C. for 4 hours. During the test, the NaCl precipitates. At the end of the 4 hours' heating, the medium is cooled to ambient temperature (20-25° C.). It adopts an orange colour with yellow particles. After decanting of the reaction medium, it is filtered over cellulose card under nitrogen pressure in a stainless steel filter. The cake is washed with 2 times 100 ml of toluene. The red-brown filtrate is evaporated in a vacuum (maximum pressure=3-4×10² Pa−maximum temperature=70° C.). A weight of 280 g of bis-monoethoxydimethylsilylpropyl tetrasulfide (0.669 mole) is then obtained in the form of a yellow-orange oil. Monitoring by ¹H-NMR, ²⁹Si—NMR and ¹³C-NMR makes it possible to check that the structure obtained is indeed in accordance with formula (VI). The average number x of sulfur atoms per molecule of MESPT, determined in known manner (elemental analysis by X-ray fluorescence and GPC) is equal to 3.9 (therefore practically equal to 4). Tables 1 and 2 show the formulation of the three compositions (Table 1—amounts of the different products expressed in phr), and their properties before and after curing (60 min at 140° C.). The vulcanization system is formed of sulfur and sulfenamide. A first comparison between the controls C-2 and C-1 clearly shows that the use of the inorganic filler (with its associated conventional coupling agent), in a high amount compared with C-1, makes it possible to obtain a very significant improvement (close to 50%) in rigidity (ME1 0), which was intended. In return, the “price to be paid” for this stiffening due to the high amount of silica is a dual one:

a significant increase (close to 45%) in the hysteresis compared with the composition C-1, which is synonymous with an increase in the temperature of the belt during operation, therefore a priori harmful to its endurance; it should be noted that this increase nevertheless remains very much less than that which would have been observed with an equivalent amount of carbon black;

processability which is extremely adversely affected (increase of 30% in the Mooney plasticity), which is detrimental to the calendering operations, to the high quality of manufacture of the metallic fabrics and to industrial productivity. The other properties are little modified between the compositions C-1 and C-2. In summary, replacement of the carbon black by silica does not make it possible to obtain a compromise of properties which is satisfactory in terms of rigidity/hysteresis/processability. A comparison, in a second phase, between the compositions C-3 and C-2 on the other hand shows that replacing the conventional coupling agent (TESPT) with the silane polysulfide of formula (I) (MESPT), according to the invention, results, unexpectedly for the person skilled in the art:

in maintaining the values of rigidity (ME11) at a satisfactory level, which is distinctly higher than the control solution with carbon black (composition C-1), while offering

a hysteresis (see tan(δ)ₘₐₓ) which is substantially reduced compared with composition C-2, which is beneficial to the rolling resistance and the overall endurance of the tire and its belt;

finally, in a major reduction in the Mooney plasticity compared with composition C-2, which is synonymous of improved processability, in particular in calendering operations. If the results recorded above already constitute an unexpected, advantageous result for the person skilled in the art, in terms of the compromise of rigidity/hysteresis/processability previously mentioned, rheometric properties which are substantially improved compared with the two controls are furthermore noted:

a higher rate constant K;

a longer induction time tᵢ (6 min instead of 4 min); and

a torque at 95% of maximum achieved in a shorter time (see t₉₅), the total vulcanization time (t₉₅-tᵢ) thus being reduced by more than 30% compared with the controls.

Reduced curing times are in particular advantageous for belts intended for complete retreading of tires, be it “cold” retreading (use of a precured belt) or conventional “hot” retreading (use of a belt in the uncured state). In this latter case, a reduced curing time, in addition to the fact that it reduces the production costs, limits the overcuring (or post-curing) imposed on the rest of the casing (“carcass”) of the worn tire, which is already vulcanized; for an identical curing time, the belts may also be cured at a lower temperature, which constitutes another means of preserving the “carcass” from the problem of overcuring mentioned above. Finally and above all, a very significant increase in the resistance to fatigue and to cracking is obtained on the composition C-3 according to the invention, compared with the controls C-1 and C-2, via the measurement of “MFTRA” (base 100 used for the control composition C-1 based on carbon black). This indicates to the person skilled in the art high endurance of the belts and tires according to the invention, with respect in particular to the problem of separation of the ends of the crown plies (“cleavage”) mentioned previously. In summary, the results of these comparative tests clearly demonstrate improved overall behaviour of the belts of tires based on a reinforcing inorganic filler and a silane polysulfide coupling agent of formula (I), compared with the use of a conventional silane polysulfide such as TESPT.

TABLE 1

| Composition No. | C-1 | C-2 | C-3 |
|---|---|---|---|
| NR (1) | 100 | 100 | 100 |
| carbon black (N330) | 52 | 10 | 10 |
| silica (2) | — | 66 | 66 |
| silane (3) | — | 6 | — |
| silane (4) | — | — | 4.6 |
| DPG (5) | — | 1 | 1 |
| ZnO | 9 | 9 | 9 |
| stearic acid | 0.7 | 2.0 | 2.0 |
| antioxidant (6) | 1.5 | 1.5 | 1.5 |
| sulfur | 6 | 4 | 4 |
| accelerator (7) | 0.9 | 1.2 | 1.2 |

(1) natural rubber;
(2) silica “Ultrasil VN3” from Degussa (BET: approximately 170-180 m²/g - CTAB: approximately 160-170 m²/g);
(3) silane polysulfide TESPT;
(4) silane polysulfide MESPT;
(5) diphenylguanidine (“Vulcacit D” from Bayer);
(6) N-1,3-dimethylbutyl-N-phenyl-para-phenylenediamine (“Santoflex 6-PPD” from Flexsys);
(7) N-dicyclohexyl-2-benzothiazyl-sulfenamide (“Santocure DCBS” from Flexsys).

TABLE 2

| Composition No. | C-1 | C-2 | C-3 |
|---|---|---|---|
| Properties before curing: | | | |
| Mooney (MU) | 52 | 68 | 61 |
| tᵢ (min) | 4 | 4 | 6 |
| t₉₅ (min) | 49.3 | 49.8 | 37.8 |
| t₉₅ − tᵢ (min) | 45.3 | 45.8 | 31.8 |
| K (min⁻¹) | 0.060 | 0.063 | 0.085 |
| Properties after curing: | | | |
| ME10 (MPa) | 9.1 | 13.3 | 12.0 |
| ME100 (MPa) | 4.8 | 4.5 | 4.3 |
| breaking stress (MPa) | 16.0 | 15.6 | 15.9 |
| elongation at break (%) | 360 | 460 | 490 |
| tan(δ)ₘₐₓ | 0.100 | 0.143 | 0.120 |
| “MFTRA” fatigue (r.u.) | 100 | 120 | 183 |

I claim:

1. A tire belt comprising a elastomeric composition based an isoprene elastomer, a reinforcing inorganic filler and a silane polysulfide, wherein said silane polysulfide satisfies the formula (I): 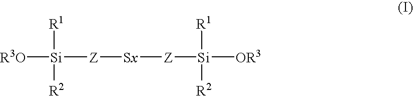
in which:
the symbols R¹ and R², which may be identical or different, each represent a monovalent hydrocarbon group selected from among the group consisting of alkyls, whether straight-chain or branched, having from 1 to 6 carbon atoms, and the phenyl radical;
the symbols R³, which may be identical or different, each represent hydrogen or a monovalent hydrocarbon group selected from among the group consisting of alkyls, whether straight-chain or branched, having from 1 to 4 carbon atoms, and alkoxyalkyls, whether straight-chain or branched, having from 2 to 8 carbon atoms;
the symbols Z, which may be identical or different, are divalent bond groups comprising from 1 to 18 carbon atoms; and
x is equal to or greater than about 2.

2. The tire belt according to claim 1, wherein the following characteristics are satisfied:
the symbols R¹ and R² are selected from among the group consisting of methyl, ethyl, n-propyl, and isopropyl;
the symbol R³ is selected from among hydrogen, methyl, ethyl, n-propyl, and isopropyl; and
the symbols Z are selected from among C₁-C₈ alkylenes.

3. The tire belt according to claim 2, wherein the following characteristics are satisfied:
the symbols R¹ and R² are selected from among methyl and ethyl;
the symbol R³ is selected from among hydrogen, methyl, and ethyl; and
the symbols Z are selected from among among C₁-C₄ alkylenes.

4. The tire belt according to claim 2, wherein Z is selected from among the group consisting of methylene, ethylene, and propylene.

5. The tire belt according to claim 4, wherein the silane polysulfide is selected from among the group consisting of bis-monoalkoxydimethylsilylpropyl polysulfides, and mixtures of these polysulfides.

6. The tire belt according to claim 5, wherein the silane polysulfide is selected from among the group consisting of bis-monoalkoxydimethylsilylpropyl polysulfides of formulae (II), (III), (IV), and mixtures of these polysulfides: 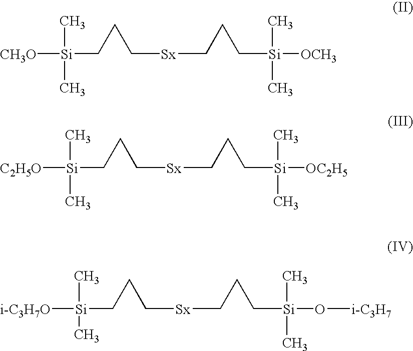
wherein x is equal to or greater than about 2.

7. The tire belt according to claim 4, wherein the silane polysulfide is a bis-(propyldimethylsilanol) polysulfide of formula (V): 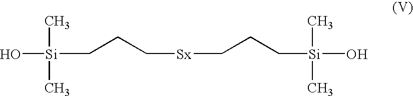
wherein x is equal to or greater than about 2.

8. The tire belt according to claim 3, wherein Z is selected, from among the group consisting of methylene, ethylene, and propylene.

9. The tire belt according to claim 8, wherein the silane polysulfide is selected from among the group consisting of bis-monoalkoxydimethylsilylpropyl polysulfides, and mixtures of these polysulfides.

10. The tire belt according to claim 9, wherein the silane polysulfide is selected from among the group consisting of bis-monoalkoxydimethylsilylpropyl polysulfides of formulae (II), (III), (IV), and mixtures of these polysulfides: 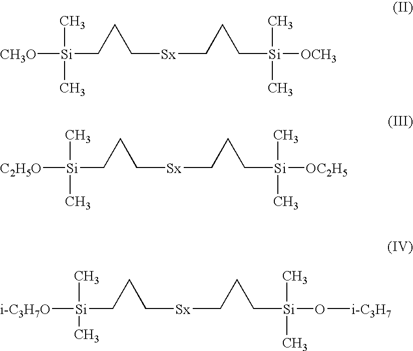
wherein x is equal to or greater than about 2.

11. The tire belt according to claim 8, wherein the silane polysulfide is a bis-(propyldimethylsilanol) polysulfide of formula (V): 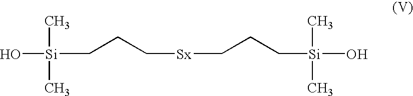
wherein x is equal to or greater than about 2.

12. The tire belt according to claim 1, wherein the polysulfide is selected from among the group consisting of disulfides (x=2), trisulfides (x=3), tetrasulfides (x=4), pentasulfides (x=5), hexasulfides (x=6), and mixtures of these polysulfides.

13. The tire belt according to claim 12, wherein the polysulfide is selected from among the group consisting of disulfides, trisulfides, tetrasulfides of bis-monoethoxydimethylsilylpropyl, and mixtures of these polysulfides.

14. The tire belt according to claim 1, wherein x is within a range from about 2 to about 5.

15. The tire belt according to claim 1, wherein the isoprene elastomer is selected from among the group consisting of natural rubber, synthetic cis-1,4 polyisoprenes, and mixtures of these elastomers.

16. The tire belt according to claim 1, wherein the amount of reinforcing inorganic filler is between about 30 and about 150 phr (parts by weight to one hundred parts of elastomer).

17. The tire belt according to claim 1, wherein the quantity of silane polysulfide is between about 2 and about 20 phr.

18. The tire belt according to claim 1, wherein the quantity of silane polysulfide represents between about 2 and about 20% by weight relative to the quantity of reinforcing inorganic filler.

19. The tire belt according to claim 1, wherein the reinforcing inorganic filler comprises more than about 50% and up to 100% of silica.

20. The tire belt according to claim 19, wherein the silica has a BET specific surface area greater than about 130 m²/g.

21. The tire belt according to claim 20, wherein the silica has a BET specific surface area within a range from about 150 to about 250 m²/g.

22. The tire belt according to claim 1, further comprising carbon black.

23. The tire belt according to claim 22, wherein the carbon black is present in an amount of between about 2 and about 20 phr.

24. A tire comprising a belt according to any one of claims 1 to 23.

25. A tire according to claim 24, wherein the tire is a heavy-vehicle tire.

26. A process for preparing a tire belt comprising at least one rubber composition based on an isoprene elastomer, a reinforcing inorganic fillers, and a silane polysulfide coupling agent, comprising the following steps:
incorporating in an isoprene elastomer, in a mixer:
a reinforcing inorganic filler;
a silane polysulfide as coupling agent;
thermomechanically kneading the entire mixture, in one or more stages, until a maximum temperature of between about 110° C. and about 190° C. is reached;
cooling the entire mixture to a temperature of less than about 100° C.;
then incorporating a vulcanization system;
kneading the entire mixture until a maximum temperature less than about 110° C. is reached;
calendering or extruding the composition thus obtained into the form of a layer of rubber; and
incorporating this layer, after optionally adding textile or metallic reinforcing threads in the tire belt;
wherein the silane polysulfide satisfies the formula (I): 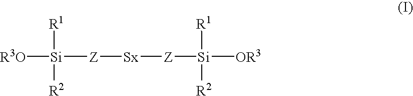
in which:
the symbols R¹ and R², which may be identical or different, each represent a monovalent hydrocarbon group selected from among the group consisting of alkyls, whether straight-chain or branched, having from 1 to 6 carbon atoms, and the phenyl radical;
the symbols R³, which may be identical or different, each represent hydrogen or a monovalent hydrocarbon group selected from among the group consisting of alkyls, whether straight-chain or branched, having from 1 to 4 carbon atoms, and alkoxyalkyls, whether straight-chain or branched, having from 2 to 8 carbon atoms;
the symbols Z, which may be identical or different, are divalent bond groups comprising from 1 to 18 carbon atoms; and
x is equal to or greater than about 2.
